(19) United States
(12) Patent Application Publication
(10) Pub. No.: US 2019/0226578 A1
(43) Pub. Date: Jul. 25, 2019

(54) CONTROL DEVICE FOR VEHICLE AND CONTROL METHOD FOR VEHICLE

(71) Applicants: JATCO Ltd, Fuji-shi, Shizuoka (JP); NISSAN MOTOR CO., LTD., Yokohama-shi, Kanagawa (JP)

(72) Inventors: Takateru KAWAGUCHI, Fuji-shi (JP); Fumitaka NAGASHIMA, Fuji-shi (JP); Hideharu YAMAMOTO, Fuji-shi (JP)

(73) Assignees: JATCO Ltd., Fuji-shi, Shizuoka (JP); NISSAN MOTOR CO., LTD., Yokohama-shi, Kanagawa (JP)

(21) Appl. No.: 16/326,870

(22) PCT Filed: Oct. 17, 2017
(86) PCT No.: PCT/JP2017/037569

§ 371 Date: Feb. 20, 2019

(30) Foreign Application Priority Data
Oct. 26, 2016 (JP) 2016-209455

(51) Int. Cl. F16H 61/12; F16H 63/34; F16H 63/48

(52) U.S. Cl. CPC F16H 61/12; F16H 63/3491; F16H 59/44; F16H 2061/1288; F16H 2061/1232; F16H 63/48

(57) ABSTRACT

A controller forms a control device for a vehicle equipped with an automatic transmission including a parking lock module. If a power transmission clutch is engaged erroneously (S2) on the basis of electrical abnormality in a solenoid part while an N range is selected (S1), the controller forcibly turns off the solenoid part to forcibly disengage the power transmission clutch (S3). Further, if a vehicle speed is equal to or less than a predetermined vehicle speed (S4), the controller applies a parking lock using the parking lock module (S5).

### TECHNICAL FIELD

The present invention relates to a control device for a vehicle and a control method for a vehicle.

### BACKGROUND ART

According to JP2007-263130A, an automatic transmission is brought to a neutral state by disengaging a forward clutch and a reverse brake while a neutral range is selected. According to JP4-300452A, an automatic transmission is brought to a neutral state by holding a predetermined engaging element in an engaged state while a neutral range is selected.

### SUMMARY OF INVENTION

An automatic transmission may encounter a fail of erroneous engagement of an engaging element while a neutral range is selected. On the occurrence of such a fail, a vehicle may unintentionally be moved even in the neutral range.

Regarding the automatic transmission disclosed in JP2007-263130A, for example, a vehicle is likely to be moved if the forward clutch or a reverse clutch is engaged erroneously while the neutral range is selected. Regarding the automatic transmission disclosed in JP4-300452A, a vehicle is likely to be moved if an engaging element except the foregoing predetermined engaging element is engaged erroneously while the neutral range is selected.

Meanwhile, some drivers may select a neutral range and apply a parking brake without selecting a parking range during parking of a vehicle. A way in which the parking brake is applied depends on driver's operation, and this may cause insufficient application of the parking brake. Hence, the occurrence of erroneous engagement of an engaging element in an automatic transmission in such a case might develop a situation in which the vehicle is moved unintentionally, regardless of whether a driver is getting out of the vehicle or whether the driver is already out of the vehicle.

The present invention has been made in view of the foregoing problem, and is intended to provide a control device for a vehicle and a control method for a vehicle capable of increasing flexibility in selecting a parking method and capable of ensuring safety against a mistake in operating a parking brake.

A control device for a vehicle according to a certain aspect of the present invention is a control device for a vehicle equipped with an automatic transmission including a parking lock mechanism. The control device includes a control unit adapted to forcibly disengage an engaging element of the automatic transmission by forcibly turning off an actuator for controlling the engaging element if the engaging element is engaged erroneously on the basis of electrical abnormality in the actuator while a neutral range is selected, and apply parking lock using the parking lock mechanism if a vehicle speed is equal to or less than a predetermined vehicle speed including a vehicle stopping speed.

According to another aspect of the present invention, a control method for a vehicle equipped with an automatic transmission including a parking lock mechanism is provided. The control method for the vehicle includes of forcibly disengaging an engaging element of the automatic transmission by forcibly turning off an actuator electrically for controlling the engaging element if the engaging element is engaged erroneously on the basis of electrical abnormality in the actuator while a neutral range is selected, and applying a parking lock using the parking lock mechanism if a vehicle speed is equal to or less than a predetermined vehicle speed including a vehicle stopping speed.

According to the foregoing aspects, as long as erroneous engagement of the engaging element is caused by electrical abnormality in the actuator, the automatic transmission can be brought to a neutral state by forcibly turning off the actuator. Thus, by permitting a parking method of selecting the neutral range and applying a parking brake, flexibility in selecting a parking method can be increased.

The automatic transmission is brought to a neutral state. Thus, even if a mistake in operating the parking brake such as insufficient application of the parking brake occurs during parking of the vehicle in the foregoing parking method, safety against such a mistake can still be ensured. Additionally, if the vehicle speed is equal to or less than the predetermined vehicle speed, a parking lock is applied automatically. Thus, even if erroneous engagement occurs for a reason except electrical abnormality, minimum required safety can be ensured.

### BRIEF DESCRIPTION OF DRAWINGS

FIG. 1 is a schematic configuration view of a vehicle;

FIG. 2 shows a principal section of a driver part; and

FIG. 3 is a flowchart showing an example of control according an embodiment.

### DESCRIPTION OF EMBODIMENTS

An embodiment of the present invention will be described below by referring to the drawings.

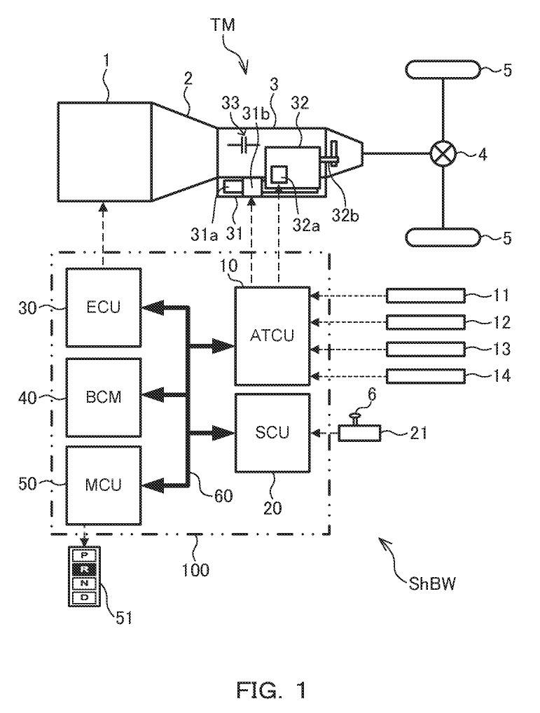

FIG. 1 is a schematic configuration view of a vehicle. The vehicle includes an engine 1 as a driving source. The power of the engine 1 is transmitted through an automatic transmission TM and a differential 4 to drive wheels 5.

The automatic transmission TM includes a torque converter 2 and a transmission mechanism 3. The automatic transmission TM has ranges including a drive (D) range, a reverse (R) range, a neutral (N) range, a parking (P) range, etc. Any one of these ranges can be set as a set range. The D range and the R range form a traveling range. The N range and the P range form a non-traveling range.

More specifically, the automatic transmission TM has a configuration equipped with a shift-by-wire system ShBW. The shift-by-wire system ShBW is configured using a shifter 6 and a shifter position sensor 21.

As the shifter 6 in the automatic transmission TM, a momentary shifter is used that is to return to a neutral position HOME as an initial position automatically after being operated. A set range in the automatic transmission TM is set by driver's operation on the shifter 6. A range selected with the shifter 6 is detected by the shifter position sensor 21. The shifter 6 is, more specifically, a shifter lever. Alternatively, the shifter 6 may be a shift switch, for example. The shift-by-wire system ShBW is configured using the transmission mechanism 3, an ATCU 10, an SCU 20, an MCU 50, a range indicator 51, etc. further.

The transmission mechanism 3 is a multistage automatic transmission mechanism, and is configured using a planet gear mechanism and a plurality of engaging elements. The engaging elements are, more specifically, friction engaging elements. The transmission mechanism 3 can change a gear ratio and can make a forward/reverse switch by changing the engaged states of the plurality of engaging elements. In the description below, a clutch and a brake as engaging elements will be called a power transmission clutch 33 collectively that are to be engaged if a set range in the automatic transmission TM is set at the traveling range.

The transmission mechanism 3 is configured using a control valve unit 31 and a parking module 32 further. The control valve unit 31 includes a solenoid part 31a and a driver part 31b.

The solenoid part 31a is configured using a plurality of solenoids SOL for controlling working hydraulic pressure in the power transmission clutch 33. The solenoid part 31a disengages the power transmission clutch 33 in an OFF state, specifically, in the absence of power supply to bring the automatic transmission TM to a neutral state. The solenoid part 31a forms an actuator for controlling the power transmission clutch 33. The driver part 31b forms a driving current circuit for the solenoid part 31a. The driver part 31b may be provided in the ATCU 10, for example.

In the automatic transmission TM equipped with the shift-by-wire system ShBW, the control valve unit 31 is not provided with a manual valve driven by driver's operational force applied during operation of selecting a range and used for switching between supply and drainage of working hydraulic pressures in the plurality of the engaging elements.

The parking module 32 locks an output shaft of the transmission mechanism 3 mechanically during parking of the vehicle. If a set range in the automatic transmission TM is set at the P range, an actuator 32a drives a parking rod 32b to a lock position. By doing so, a engaging click not shown in the drawings engages with a parking gear not shown in the drawings provided at the output shaft of the transmission mechanism 3, thereby mechanically lock the output shaft of the transmission mechanism 3 (parking locked state). By contrast, if a set range in the automatic transmission TM is set at a range except the P range, the actuator 32a drives the parking rod 32b to a lock releasing position. This releases the engaging click and the parking gear not shown in the drawings from the engaging to release the output shaft of the transmission mechanism 3 from the lock (parking lock released state).

The ATCU 10 corresponds to a control unit for the automatic transmission TM and controls the automatic transmission TM. The ATCU 10 receives signals input from an accelerator opening sensor 11 for detecting an accelerator opening APO indicating the amount of operation on an accelerator pedal, a vehicle speed sensor 12 for detecting a vehicle speed VSP, a parking position sensor 13 for detecting the position of the parking rod 32b in the parking module 32, a rotation speed sensor 14 for detecting a turbine rotation speed Ntbn in the torque converter 2, etc.

The ATCU 10 is connected through a CAN 60 to the SCU 20, an ECU 30, a BCM 40, and the MCU 50 so as to be capable of communicating with the SCU 20, the ECU 30, the BCM 40, and the MCU 50 mutually.

The SCU 20 is a shift control unit. The SCU 20 generates a requested range signal corresponding to a range selected with the shifter 6 on the basis of a signal from the shifter position sensor 21, and outputs the generated signal to the ATCU 10.

The ATCU 10 sets a set range in the automatic transmission TM on the basis of the requested range signal from the SCU 20. The ATCU 10 outputs a control command value to the control valve unit 31 in accordance with the set range in the automatic transmission TM, as described next.

If a range in the automatic transmission TM is set at the D range, the ATCU 10 determines a target gear position by referring to a shift map on the basis of the vehicle speed VSP and the accelerator opening APO. Then, the ATCU 10 outputs the control command value for attaining the target gear position to the control valve unit 31. By doing so, the solenoid part 31a is controlled in accordance with the control command value and working hydraulic pressure in the power transmission clutch 33 is adjusted, thereby attaining the target gear position.

If a set range in the automatic transmission TM is set at the R range, the ATCU 10 executes R range control. The R range control is shift control executed on the automatic transmission TM if the R range is selected, and is intended to attain a reverse position. In the R range control, the target gear position is set at the reverse position, and a control command value for attaining the target gear position is output to the control valve unit 31. In this case, the solenoid part 31a is controlled so as to attain the reverse position.

If a set range in the automatic transmission TM is set at the P range or the N range, the ATCU 10 outputs a control command value for disengaging the power transmission clutch 33 to the control valve unit 31. If the set range is the P range, the ATCU 10 further operates the actuator 32a in the parking module 32 to bring the automatic transmission TM to the parking locked state.

The ECU 30 is an engine control unit and controls the engine 1. The ECU 30 outputs a rotation speed NE of the engine 1, a throttle opening TVO, etc. to the ATCU 10.

The BCM 40 is a body control module and controls an operating element belonging to a vehicle body. The operating element belonging to the vehicle body is a door lock mechanism of the vehicle, for example, and includes a starter for the engine 1. The BCM 40 outputs an ON/OFF signal about a door lock switch for detecting the lock of a door of the vehicle, an ON/OFF signal about an ignition switch for the engine 1, etc. to the ATCU 10.

The MCU 50 is a meter control unit, and controls a meter, a warning lamp, a display, the range indicator 51 on which a set range in the automatic transmission TM is displayed, etc. provided inside the vehicle.

The ATCU 10, the SCU 20, the ECU 30, the BCM 40, and the MCU 50 form a controller 100 serving as a control device for the vehicle according to the embodiment.

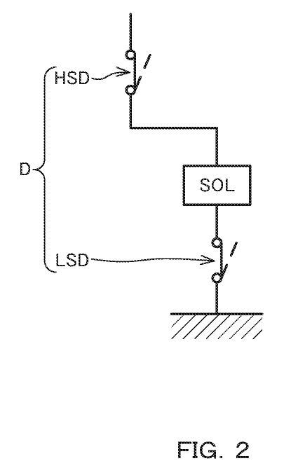

FIG. 2 shows a principal section of the driver part 31b. More specifically, the driver part 31b is configured using a plurality of drivers D each being a driver provided for corresponding to one of the plurality of the solenoids SOL. The driver D includes a high-voltage side driver HSD and a low-voltage side driver LSD.

The high-voltage side driver HSD is formed at a section belonging to the driving current circuit for the solenoid SOL and being placed at a higher voltage than the solenoid SOL. The low-voltage side driver LSD is formed at a section belonging to the driving current circuit for the solenoid SOL and being placed at a lower voltage than the solenoid SOL. The high-voltage side driver HSD and the low-voltage side driver LSD are both configured to be capable of disconnecting and connecting the solenoid SOL electrically on the driving current circuit.

Thus, making the solenoid SOL electrically disconnected on the driving current circuit using the high-voltage side driver HSD and the low-voltage side driver LSD makes it possible to forcibly bring the solenoid SOL to a state in the absence of power supply. Specifically, turning off both the high-voltage side driver HSD and the low-voltage side driver LSD connected to the solenoid SOL makes it possible to forcibly turn off the solenoid SOL.

The automatic transmission TM may encounter a fail of erroneous engagement of the power transmission clutch 33 while the N range is selected. On the occurrence of such a fail, the vehicle may unintentionally be moved even in the N range. For example, even if the N range is selected while a set range is other than the N range in the automatic transmission TM, engaging the power transmission clutch 33 erroneously so as to attain a certain gear position may unintentionally move the vehicle.

Meanwhile, some drivers may select the N range and apply a parking brake without selecting the P range during parking of the vehicle. A way in which the parking brake is applied depends on driver's operation, and this may cause insufficient application of the parking brake. Hence, the occurrence of erroneous engagement of the power transmission clutch 33 in such a case might develop a situation in which the vehicle is moved unintentionally, regardless of whether a driver is getting out of the vehicle or whether the driver is already out of the vehicle.

In view of the foregoing circumstances, in the embodiment, the controller 100 executes control described next.

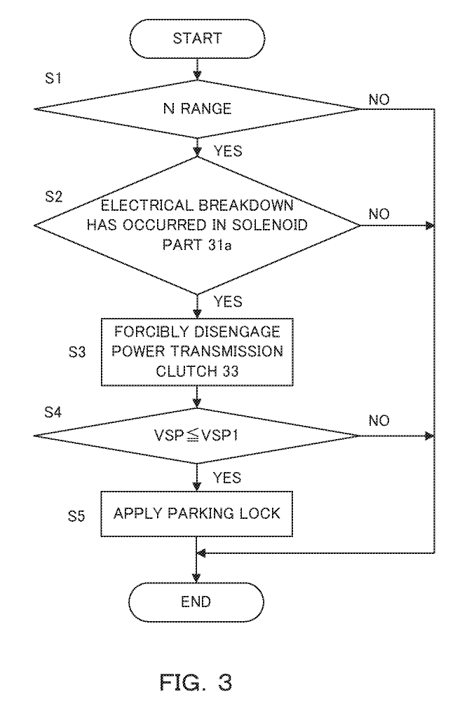

FIG. 3 is a flowchart showing an example of control executed by the controller 100. Each process shown in this flowchart can be performed by the ATCU 10, for example.

In step S1, the controller 100 determines whether a set range in the automatic transmission TM is the N range. If a negative determination is made in step S1, the processing shown in the flowchart is finished once. If a positive determination is made in step S1, the N range is determined to be selected. Then, the processing proceeds to step S2.

In step S2, the controller 100 determines whether electrical breakdown has occurred in the solenoid part 31a. Examples of the electrical breakdown include disconnection, faulty connection to a power supply, and faulty connection to the ground. The occurrence of the electrical breakdown can be determined by publicly-known techniques, and other appropriate techniques. If a negative determination is made in step S2, the processing shown in the flowchart is finished once. If a positive determination is made in step S2, the processing proceeds to step S3.

In step S3, the controller 100 forcibly disengages the power transmission clutch 33. In the automatic transmission TM equipped with the shift-by-wire system ShBW, if all the plurality of the solenoids SOL forming the solenoid part 31a is OFF, the power transmission clutch 33 is disengaged to achieve a neutral state.

Meanwhile, an engaging element corresponding to a normal solenoid SOL can be disengaged normally while the N range is selected. Thus, in step S3, the controller 100 forcibly turns off a solenoid SOL in which electrical breakdown has occurred using the high-voltage side driver HSD and the low-voltage side driver LSD corresponding to this solenoid SOL.

By doing so, if the power transmission clutch 33 is engaged erroneously on the basis of the electrical abnormality in the solenoid part 31a while the N range is selected, the power transmission clutch 33 can be disengaged forcibly by forcibly turning off the solenoid part 31a. As a result, it becomes possible to bring the automatic transmission TM to a neutral state.

Turning off the solenoid part 31a forcibly includes forcibly turning off the solenoid SOL belonging to the solenoid part 31a and in which the electrical breakdown has occurred, and turning off the normal solenoid SOL normally corresponding to a different engaging element to be disengaged, as described above. This also applies to turning off both the high-voltage side driver HSD and the low-voltage side driver LSD connected to the solenoid part 31a.

In step S4, the controller 100 determines whether the vehicle speed VPS is equal to or less than a predetermined vehicle speed VSP1. The predetermined vehicle speed VSP1 is a vehicle stopping speed used for determining that the vehicle has been stopped, and is set at a value larger than zero. The predetermined vehicle speed VSP1 may be set to be larger than the vehicle stopping speed within a range in which parking lock can be applied safely. Specifically, if the vehicle speed VSP is equal to or less than the predetermined vehicle speed VSP1, the vehicle speed VSP may include the vehicle stopping speed and may include zero. The predetermined vehicle speed VSP1 can be set in advance by experiment, for example. If a negative determination is made in step S4, the processing shown in the flowchart is finished once. If a positive determination is made in step S4, the processing proceeds to step S5.

In step S5, the controller 100 applies a parking lock using the parking module 32. In this way, the parking lock is applied to the automatic transmission TM in the neutral state. After step S5, the processing shown in the flowchart is finished once.

Major action and effect of the embodiment will be described next.

The controller 100 forms the control device for the vehicle equipped with the automatic transmission TM including the parking module 32. If the power transmission clutch 33 is engaged erroneously on the basis of electrical abnormality in the solenoid part 31a while the N range is selected, the controller 100 forcibly disengages the power transmission clutch 33 by forcibly turning off the solenoid part 31a. Further, if the vehicle speed VSP is equal to or less than the predetermined vehicle speed VSP1, the controller 100 applies a parking lock using the parking module 32.

More specifically, in the flowchart shown in FIG. 3, the controller 100 performs the process in step S3 after making a positive determination in step S2. Then, the controller 100 performs the process in step S5 after making a positive determination in step S4. By doing so, the controller 100 is configured to include a control unit for the foregoing forcible disengagement and application of the parking lock.

In this configuration, as long as erroneous engagement of the power transmission clutch 33 is caused by electrical abnormality in the solenoid part 31a, the automatic transmission TM can be brought to a neutral state by forcibly turning off the solenoid part 31a. Thus, by permitting a parking method of selecting the N range and applying a parking brake, flexibility in selecting a parking method can be increased during parking of the vehicle.

The automatic transmission TM is brought to a neutral state. Thus, even if a mistake in operating the parking brake such as insufficient application of the parking brake occurs during parking of the vehicle in the foregoing parking method, safety against such a mistake can be ensured. Additionally, if the vehicle speed VSP is equal to or less than the predetermined vehicle speed VSP1, a parking lock is applied automatically. Thus, even if erroneous engagement occurs for a reason except electrical abnormality, minimum required safety can still be ensured.

In the embodiment, the solenoid part 31a is forcibly turned off by turning off both the high-voltage side driver HSD and the low-voltage side driver LSD connected to the solenoid part 31a.

In this configuration, irrespective of whether electrical abnormality having occurred in the solenoid part 31a is either faulty connection to a power supply or faulty connection to the ground, for example, the power transmission clutch 33 can forcibly be disengaged reliably.

The embodiment of the present invention is as described above. However, the foregoing embodiment is merely described as an example of the application of the present invention. The technical scope of the present invention is not intended to be limited to the specific configuration described in the foregoing embodiment.

In the foregoing embodiment, the high-voltage side driver HSD and the low-voltage side driver LSD forcibly turn off a solenoid SOL in which electrical breakdown has occurred, thereby forcibly turning off the solenoid part 31a. Alternatively, the high-voltage side driver HSD and the low-voltage side driver LSD may be configured to forcibly turn off the solenoid part 31a entirely, specifically, to forcibly turn off all the plurality of the solenoids SOL, for example.

In the foregoing embodiment, the controller 100 is configured to include the control unit. Alternatively, the control unit may be a unit fulfilled functionally using a single controller such as the ATCU 10, for example, to be understood functionally as a configuration belonging to this controller.

In the foregoing embodiment, the automatic transmission TM is described as a multistage automatic transmission. Alternatively, the automatic transmission TM may be a continuously variable transmission, for example.

The present application claims a priority based on Japanese Patent Application No. 2016-209455 filed with the Japan Patent Office on Oct. 26, 2016, all the contents of which are hereby incorporated by reference.

1. A control device for a vehicle equipped with an automatic transmission including a parking lock mechanism, comprising:
a controller adapted to forcibly disengage an engaging element of the automatic transmission by forcibly turning off an actuator for controlling the engaging element if the engaging element is engaged erroneously on the basis of electrical abnormality in the actuator while a neutral range is selected, and apply a parking lock using the parking lock mechanism if a vehicle speed is equal to or less than a predetermined vehicle speed including a vehicle stopping speed, and if the erroneous engagement occurs while the neutral range is selected.

2. The control device for the vehicle according to claim 1, wherein
the actuator is forcibly turned off by turning off both a high-voltage side driver and a low-voltage side driver connected to the actuator.

3. A control method for a vehicle equipped with an automatic transmission including a parking lock mechanism, comprising:
forcibly disengaging an engaging element of the automatic transmission by forcibly turning off an actuator electrically for controlling the engaging element if the engaging element is engaged erroneously on the basis of electrical abnormality in the actuator while a neutral range is selected, and applying a parking lock using the parking lock mechanism if a vehicle speed is equal to or less than a predetermined vehicle speed including a vehicle stopping speed, and if the erroneous engagement occurs while the neutral range is selected.

4. A control device for a vehicle equipped with an automatic transmission including a parking lock mechanism, comprising:
control means for forcibly disengaging an engaging element of the automatic transmission by forcibly turning off an actuator for controlling the engaging element if the engaging element is engaged erroneously on the basis of electrical abnormality in the actuator while a neutral range is selected, and applying a parking lock using the parking lock mechanism if a vehicle speed is equal to or less than a predetermined vehicle speed including a vehicle stopping speed, and if the erroneous engagement occurs while the neutral range is selected.
